(19) United States
(12) Patent Application Publication
(10) Pub. No.: US 2015/0066616 A1
(43) Pub. Date: Mar. 5, 2015

(54) Systems, Computer-Implemented Methods, and Non-Transitory Computer-Readable Media for Social Request Routing and Reward Distribution

(71) Applicants: Dustin Matthew Bray, Snellville, GA (US); Ying Xie, Marietta, GA (US)

(72) Inventors: Dustin Matthew Bray, Snellville, GA (US); Ying Xie, Marietta, GA (US)

(21) Appl. No.: 14/331,098

(22) Filed: Jul. 14, 2014

Related U.S. Application Data
(60) Provisional application No. 61/846,595, filed on Jul. 15, 2013.

(51) Int. Cl. G06Q 30/02; H04L 29/08; G06Q 50/00

(52) U.S. Cl. CPC G06Q 30/0214; G06Q 50/01; H04L 67/22
USPC 705/14.16

(57) ABSTRACT

Systems, computer-implemented methods, and non-transitory computer-readable media for social request routing and reward distribution. In a computer-implemented method according to one embodiment of the invention: a request is created, the request is routed between one or more users of one or more social networks, the request is fulfilled, rewardable users are rewarded based on the request's successful forwarding path(s). The invention may be used to fulfill requests that require cooperation between potentially unacquainted individuals.

### CROSS REFERENCE TO RELATED APPLICATION

The present application claims priority to, co-pending U.S. provisional patent application no. 61846595 filed Jul. 15, 2013, and entitled “System and Method for Social Request Routing and Reward Distribution”. The entire contents of the above-referenced patent application are incorporated by reference herein.

### STATEMENT REGARDING FEDERALLY SPONSORED RESEARCH OR DEVELOPMENT

“Not Applicable”

### REFERENCE TO SEQUENCE LISTING, A TABLE, OR COMPUTER PROGRAM LISTING COMPACT DISC APPENDIX

“Not Applicable”

### BACKGROUND

1. Field of the Invention

The present invention relates generally to social networking and more particularly to systems, computer-implemented methods, and non-transitory computer-readable media for request social routing and reward distribution.

2. Description of Related Art

A person will sometimes need to locate and interact with a previously unknown person in order to accomplish some specific purpose. For example, a person may want to gain something from another person (possibly by borrowing or purchasing), or a person may want to provide something to others (possibly by selling). In other words, the requester (the person wanting to initiate interaction) wants to deliver the request (a contract for interaction) to one or more targets (people who can fulfill the request to the satisfaction of the requester).

Conventionally, a requester may attempt to accomplish this online by publishing generally informal requests through various services. However, this approach often gives rise to issues related to relevance, authenticity, and participation.

Because a request's target is unknown, the request will likely need to be viewed by multiple viewers before it can be discovered by an intended target. An individual request may be relevant to some viewers but irrelevant to others, and an individual viewer has a limited capacity to view requests. Searching for relevant requests requires additional work from the viewer. In order to improve efficiency, it would be useful to increase relevance and control the request population.

Online interest groups, such as message boards, provide a higher level of relevance to viewers of requests because members often share similar interests and/or attributes. For example, a blind person living in Atlanta may want to locate other blind people in the area to better learn about available resources. A forum specifically catering to the blind in Atlanta would likely fulfill this need. But while such interest groups provide improved relevance, they are still limited by specificity. For example, consider that there are likely numerous separate groups relating to broad topics such as Atlanta residents, Spanish speakers, and disabled teenagers, but it is unlikely there exists one group specifically relevant to Spanish speaking disabled teenagers living in Atlanta. Even if such a specific group does exist, it may be difficult to locate. And because interest groups generally pertain to groups with large populations (such as all residents of a particular geographical region, all enthusiasts of a particular sport, etc.), members are not likely to share any known personal connections, thereby encouraging anonymity. With no known personal connections, there may be no convenient way to verify if a particular member is authentic. The rise of catphishing scams demonstrates the ease with which malicious individuals can project false personae₁. (And in the case of bots, users may not be interacting with entities that are even human.) This situation can be unfavorable for personal interactions such as financial transactions or online dating. In order to improve authenticity, it would be useful to orient communication based on existing social connections.

Social networking services often provide a greater degree of authenticity, but lesser relevance than interest groups. While many of a person's interests likely overlap those of current friends and family, the interests of a person's social circle are likely very diverse. As a result, an individual user's requests may be irrelevant to the majority of his/her connections. For example, a person who enjoys playing online collaborative games may broadcast requests encouraging others to join. Such requests may become an annoyance to those who have little interest. As a result, users may lose motivation to view requests if they find them largely irrelevant. In addition, requests are likely viewed by only a small portion of a user's acquaintances due to the sheer volume of content aggregated through the social networking service₂. In order to improve relevance to those viewing requests, it would be useful to control broadcasting and/or limit the overall volume of requests. Also, the small population of available social connections related to one particular interest may not provide sufficient opportunities to a requester as would a large interest group. Therefore, a requester will likely want to establish connections beyond those of his/her immediate social circle.

Communication routed through the requester's extended social network may provide improved authenticity and better relevance, but peer-to-peer communication may suffer from low participation. As an example of improved authenticity and relevance, a “blind date” set up through a mutual friend may be more desirable than an encounter with a stranger from an online interest group having no obvious social connections. The mutual friend likely has better knowledge of each parties' trustworthiness and compatibility. Likewise, each party likely has some knowledge of the mutual friend's ability to judge a good match. The small world experiments₃ demonstrate the ability to route requests to targets within a social network using a relatively small number of intermediate hops. Each hop may be able to provide more information to reach the desired target; however, the reliability depends heavily on the full participation of each person in the delivery chain.

Current advertising techniques can be used as examples to further illustrate these issues of relevance, authenticity, and participation. Advertisements are a special type of request in which the advertiser (requester) wishes to provide something to the consumer (target) for sale. Conventionally, advertising involves broadcasting advertisements in hopes they will be discovered by willing customers. Advertisers often want to maximize the visibility of ads, which may deliver more ads to interested customers, but frequently at the cost of annoying other viewers. “Spam” may be an example of this kind of advertisement strategy. Spammers typically show little care for the personal relevance of advertisements to viewers. Viewers may even become conditioned to ignore advertisements (such as the so called “banner blindness” to ads on webpages). Typical targeted advertising attempts to improve relevance by choosing advertisements based on data collected about the viewer (such as previous purchases from a store or user profile data in a social network). Typical targeted advertising frequently lacks personal knowledge about what the viewer actually wants or needs. In addition, the Internet is saturated with examples of inauthentic advertising. In particular, advertisers will often deceptively promote their own products and services online through positive reviews seemingly published by satisfied customers—a practice known as “astroturfing.” With no personal connection, it may be difficult for a viewer to evaluate the validity of an advertisement's claims. Finally, conventional advertising is mostly designed for passive consumption and assumes a low level of participation from viewers. Despite efforts to combine social media and advertising, it still seems difficult to engage new customers in a significant way₄. Though users have the ability to tell their friends about products they like, there may actually be little motivation to do so.

### BRIEF SUMMARY OF THE INVENTION

The present invention provides systems, computer-implemented methods, and non-transitory computer-readable media for social request routing and reward distribution. In a computer-implemented method according to one embodiment of the invention, a request is created, the request is routed between one or more users of one or more social networks, the request is fulfilled, rewardable users are rewarded based on the request's successful forwarding path(s).

### BRIEF DESCRIPTION OF THE DRAWINGS

FIG. 1 illustrates a schematic diagram showing an exemplary network environment.

FIG. 2 illustrates a block diagram of one exemplary embodiment of a routing and rewarding system.

FIG. 3 illustrates a sequence diagram showing abstract exemplary interactions.

FIG. 4 illustrates an exemplary social graph depicting users and their connections.

FIG. 5 illustrates an exemplary social graph depicting successful forwarding paths.

FIG. 6 illustrates a table showing an exemplary request structure with sample data.

FIG. 7A illustrates an exemplary dating request creation screen.

FIG. 7B illustrates an exemplary advertisement request creation screen.

FIG. 7C illustrates an exemplary medical request creation screen.

FIG. 7D illustrates an exemplary chat request creation screen.

FIG. 7E illustrates an exemplary ride share request creation screen.

FIG. 8 illustrates two views of an exemplary screen for viewing a collection of requests.

FIG. 9A illustrates an exemplary dating request view screen.

FIG. 9B illustrates an exemplary advertisement request view screen.

FIG. 9C illustrates an exemplary medical request view screen.

FIG. 9D illustrates an exemplary chat request view screen.

FIG. 9E illustrates an exemplary ride share request view screen.

FIG. 10 illustrates an exemplary diagram showing several users, screens, and interactions.

FIG. 11A illustrates an exemplary forwarding path with screens associated with each user and a detailed view of the requester's creation screen.

FIG. 11B illustrates an exemplary diagram showing the request view screen of the second user in the exemplary forwarding path.

FIG. 11C illustrates an exemplary diagram showing the request view screen of the third user in the exemplary forwarding path.

FIG. 11D illustrates an exemplary diagram showing the request view screen of the fourth user in the exemplary forwarding path.

FIG. 11E illustrates an exemplary diagram showing the request view screen of the fifth user in the exemplary forwarding path.

FIG. 12 illustrates an exemplary sequence diagram describing an exemplary scenario.

FIG. 13 illustrates a flow chart of an exemplary computer-implemented method for social request routing and reward distribution.

### DETAILED DESCRIPTION AND BEST MODE OF IMPLEMENTATION

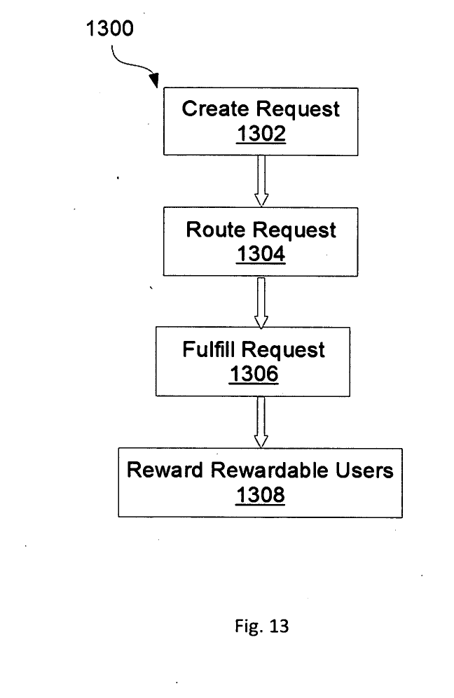

The present invention provides systems, computer-implemented methods, and non-transitory computer-readable media for social request routing and reward distribution. In a method according to one embodiment of the invention, a request is created, the request is routed between one or more users of one or more social networks, the request is fulfilled, rewardable users are rewarded based on the request's successful forwarding path(s). FIG. 13 illustrates an exemplary flow chart of the method. At step 1302, a request is created. According to various embodiments, creating a request comprises receiving data related to the request from a user (hereinafter referred to as a “requester”), and storing the request in a non-transitory computer-readable medium. At step 1304, the request may be routed between one or more users of one or more social networks. According to one embodiment, the routing process is initiated using input selections indicating one or more of the requester's contacts found in the forwarding information of the request received from the requester. At step 1306, the request may be fulfilled by a user who has access to the request. According to some embodiments, the request may continue to be routed even after it has been fulfilled so that other users may be able to fulfill it also. If the request has been fulfilled, rewardable users may be rewarded based on the request's successful forwarding paths at step 1308.

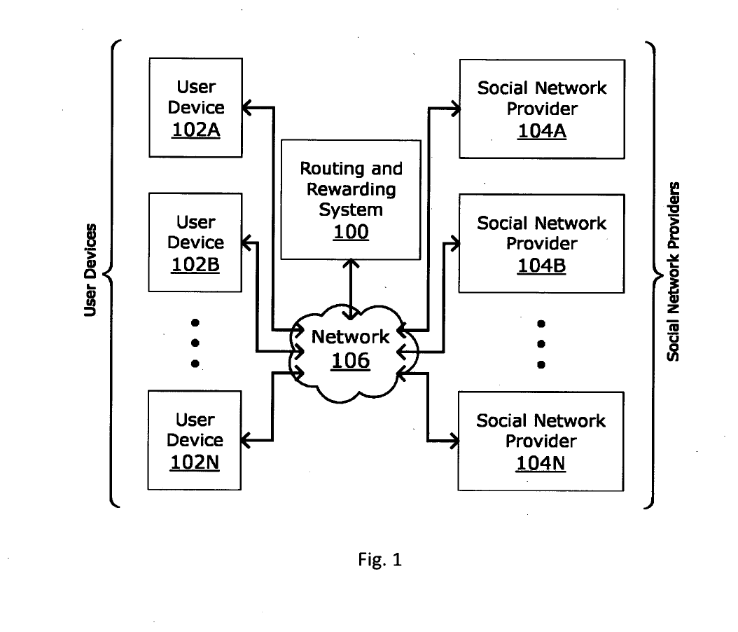

FIG. 1 illustrates a schematic diagram showing an exemplary network environment in which various example routing and rewarding system embodiments may operate. One or more user devices 102, such as a user device A 102A, a user device B 102B, and up to a user device N 102N, are in communication with a routing and rewarding system 100 via a network 106. A user device may comprise any device associated with one or more users such as a desktop computer, a cellular phone, and so forth. The routing and rewarding system 100 is in communication with one or more social network providers 104, such as a social network provider A 104A, a social network provider B 104B, and up to a social network provider N 104N. A social network provider may comprise any user or entity that provides social networking services or communication services. Accordingly, the routing and rewarding system 100 may use the one or more social network providers 104A-N to authenticate users and/or discover connections between users 102A-N. Furthermore, the routing and rewarding system 100 may further be configured to track and store social identification information, such as email address, OpenID, social network website user IDs, and so on, for each user according to various embodiments. Accordingly, the routing and rewarding system 100 may be able to use this information to store references to users in a request's forwarding information as described herein. For example, in one embodiment, the routing and rewarding system 100 may communicate with a social network hosted with the routing and rewarding system 100 to reference users by their account IDs assigned through the social network.

A user's connections (hereinafter also referred to as “friends”) comprise any other users or entities with whom the user is directly socially connected through one or more of the social networking providers 104A-N. Connections may comprise email contacts, friend and family connections on social networking websites, and so on. Accordingly, the routing and rewarding system 100 (FIG. 1) allows users to interact with each other and access content, such as requests, as described herein. For example, the routing and rewarding system 100 may host a website, via physical servers, allowing users to create, view, and otherwise interact with content as well as interact with one another.

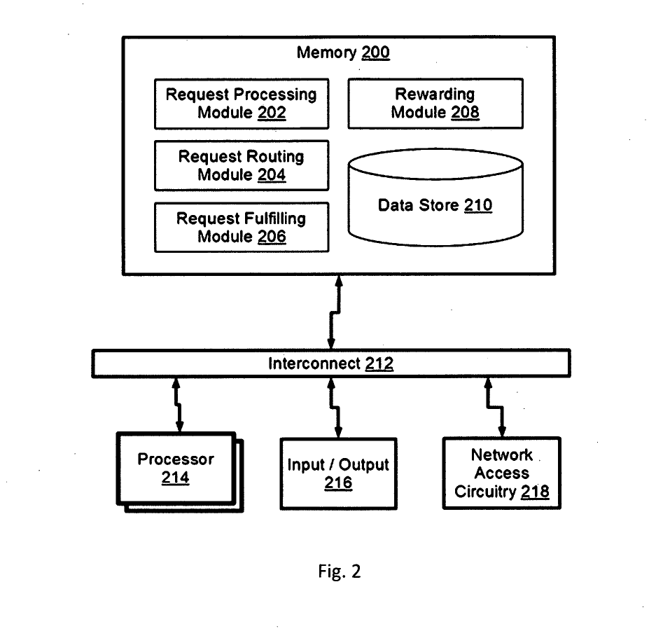

FIG. 2 illustrates a block diagram of some computer elements of one example embodiment of the routing and rewarding system 100 (FIG. 1) comprising: memory 200, one or more processors 214, one or more input and/or output devices 216 and network access circuitry 218 connected to one another through an interconnect 212 which, in this illustrative embodiment, is a bus. A set of instructions is stored in memory 200, which when executed by one or more processors 214, cause the one or more processors 214 to perform operations described herein. According to the exemplary embodiment depicted in FIG. 2, the set of instructions comprises: a request processing module 202 which implements creating requests, a request routing module 204 which implements routing requests between one or more users of one or more social networks, a request fulfilling module 206 which implements fulfilling requests, a rewarding module 208 which implements rewarding rewardable users based on a request's successful forwarding path(s). One or more data stores 210 may be used to store data, for example requests. Network access circuitry 218 sends and receives data through a computer network, such as a local area network (LAN) or the Internet for example. Any of the routing and rewarding system's 100 (FIG. 1) functionality may be performed by distributed processing devices in communication over a network according to various implementations. The components described above are intended as example possibilities, and not intended to limit the scope of the invention.

According to some embodiments, routing comprises determining, from the connections of a user who has access to the request (herein after also referred to as a “forwarding user”), one or more receiving users who appear best suited to route the request toward the request's target(s), and forwarding the request to the one or more receiving users. Accordingly, the routing and rewarding system 100 (FIG. 1) and/or users may be able to propagate a request from user to user, through one or more social networks, toward the target(s). According to exemplary embodiments, the method used to determine receiving users from a forwarding user's connections may influence the spread of requests through the social network(s). For example, an embodiment that allows less restricted routing may determine most or even all of a forwarding user's connections best suited. This kind of method might be useful in situations where a request has a large number of targets, as in traditional advertising. Alternatively, an exemplary embodiment that employs more conservative routing may determine only a few or even just one of the forwarding user's connections best suited, which may facilitate more targeted routing through a fewer number of users. Yet other exemplary embodiments may use methods that comprise a combination of unrestricted and conservative routing techniques to determine receiving users in response to such factors as congestion of the flow of requests within the social network(s) for example. More methods for determining receiving users may be used and still fall within the scope of various embodiments.

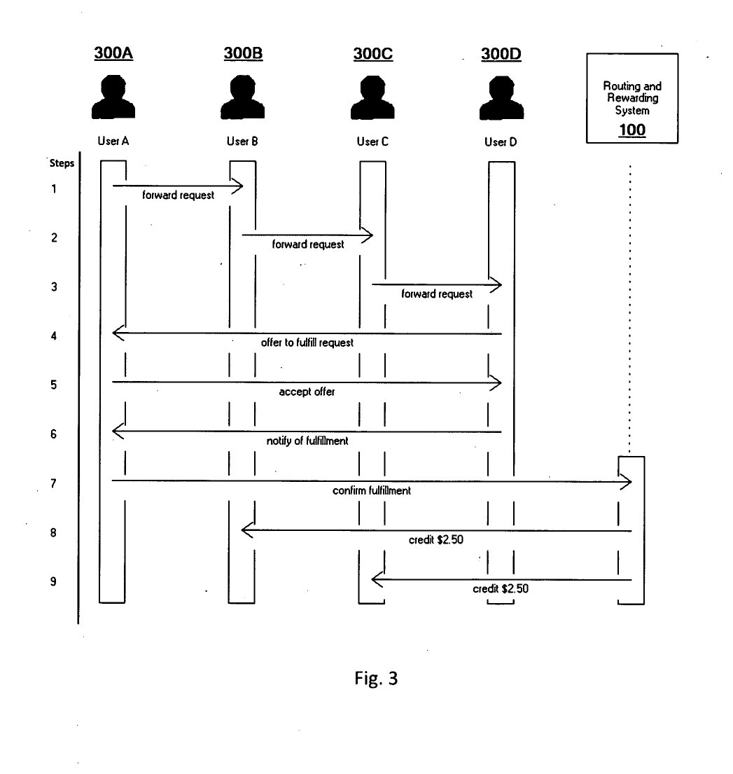

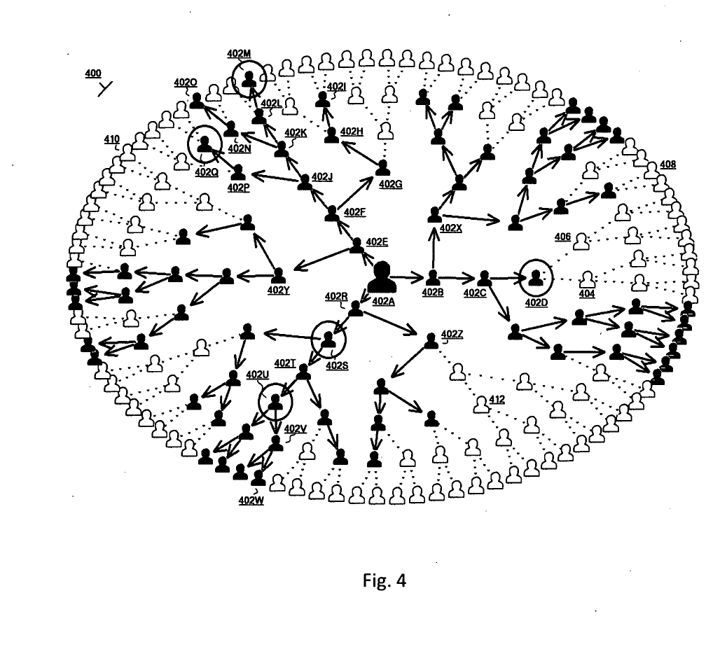

According to one embodiment, forwarding a request to a receiving user comprises storing data in the request's forwarding information indicating that the request has been forwarded to the receiving user, and granting, to the receiving user, access to the request. FIG. 3 illustrates an exemplary sequence diagram showing, in abstract, interactions between exemplary users 300A-300D and the routing and rewarding system 100 (FIG. 1). At step 1, user A 300A forwards the request to his/her connection user B 300B. User B 300B then has access to the request, and the request's forwarding information contains a record of the forward from User A 300A to User B 300B. Then at step 2, User B 300B forwards the request to user C 300C. Then at step 3, user C 300C forwards the request to user D 300D. FIG. 4 illustrates an exemplary social graph depicting users and their connections. This figure is provided for didactic purposes. Only a few connections are shown for each user. Each arrow shows how the request is forwarded from a forwarding user to a receiving user. Beginning with the requester 402A, the request is forwarded to three receiving users: user B 402B, user E 402E, and user R 402R. The receiving users then have access to the request. The request is then forwarded from user B 204B to user C 402C and user X 402X, from user E 402E to user F 402F and user Y 402Y, from user 402R to user S 402S and user Z 402Z, and so on. Non-receiving users, such as user 404, user 406, user 408, user 410, user 412, and so on, do not have access to the request.

According to one embodiment, a forwarding path comprises a sequence representing one path by which the request was forwarded from the requester to an individual receiving user. For example, FIG. 4 contains the forwarding path user A 402A→user B 402B→user C 402C→user D 402D. It should be noted that forwarding paths can overlap. For example, the path user A 402A→user E 402E→user F 402F→user G 402G→user H 402H→user I 402I partially overlaps the path user A 402A→user E 402E→user F 402F→user J 402J→user K 402K→user N 402N→user O 402O. Accordingly, a request's forwarding paths are represented in the request's forwarding information. For example, a list of references to users representing a forwarding path might be constructed by traversing the request's forwarding information starting with the reference to the requester and continuing through references to single receiving users. (A reference to a user may comprise any data used to uniquely identify a user of the system, such as a user ID.) An alternative exemplary method might traverse the request's forwarding information starting with a reference to a user and continuing backward through references to forwarding users until a reference to the requester is reached.

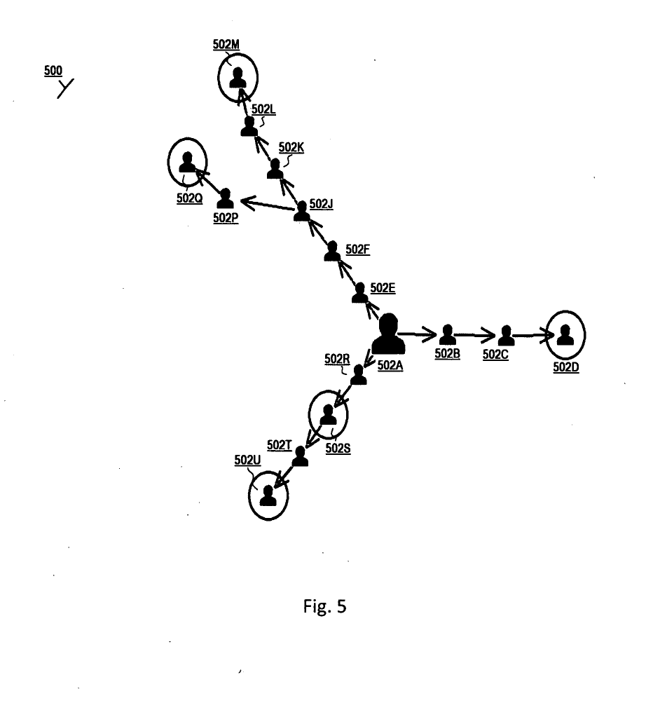

A successful forwarding path comprises a forwarding path terminating in a reference to a fulfiller. A fulfiller comprises any user who has fulfilled the request as described herein. Referring to FIG. 3, steps 1 through 7 show an exemplary interaction resulting in a successful forwarding path. At step 7, user D 300D is a fulfiller of the request. The forwarding path user A 300A→user B 300B→user C 300C→user D 300D is then a successful forwarding path. This path corresponds to the path user A 402A→user B 402B→user C 402C→user D 402D in FIG. 4. FIG. 5 illustrates an exemplary social graph depicting successful forwarding paths corresponding to those in FIG. 4. It should be noted that successful forwarding paths can overlap. For example, the path user A 502A→user E 502E→user F 502F→user J 502J→user K 502K→user L 502L→user M 502M partially overlaps the path user A 502A→user E 502E→user F 502F→user J 502J→user P 502P→user Q 502Q. In this case, both user M 502M and user Q 502Q fulfilled the request. And the path user A 502A→user R 502R→user S 502S→user T 502T→user U 502U completely overlaps the path user A 502A→user R 502R→user S 502S. In this case, user S 502S both fulfilled and forwarded the request.

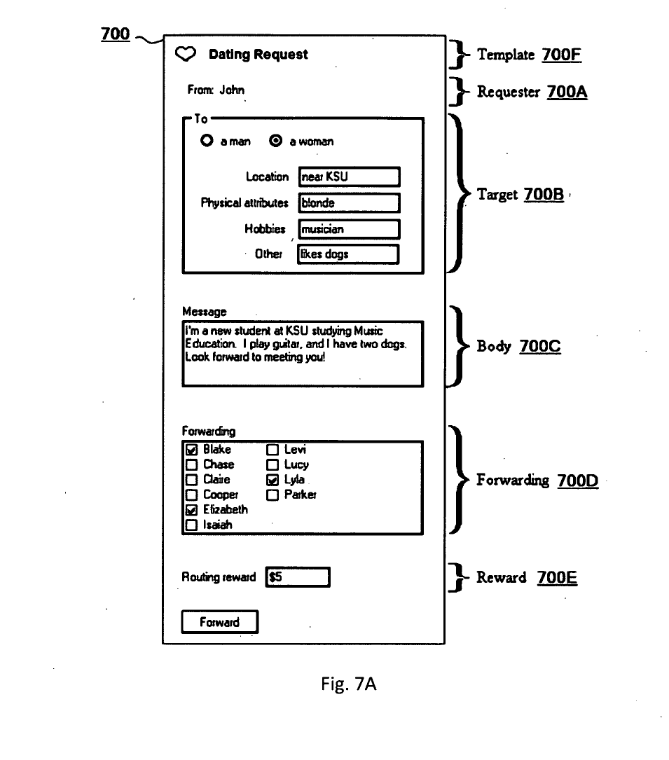

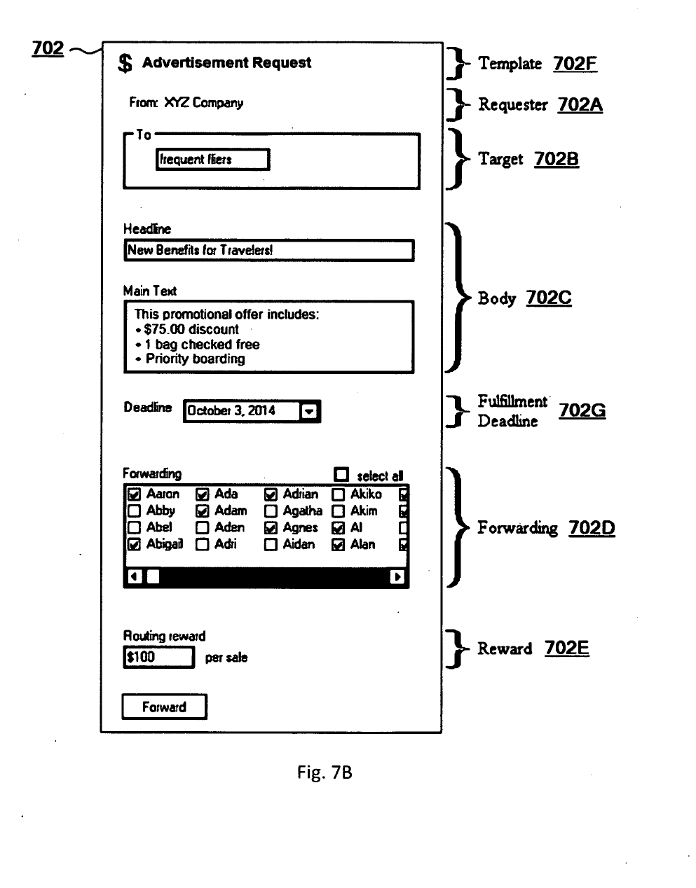

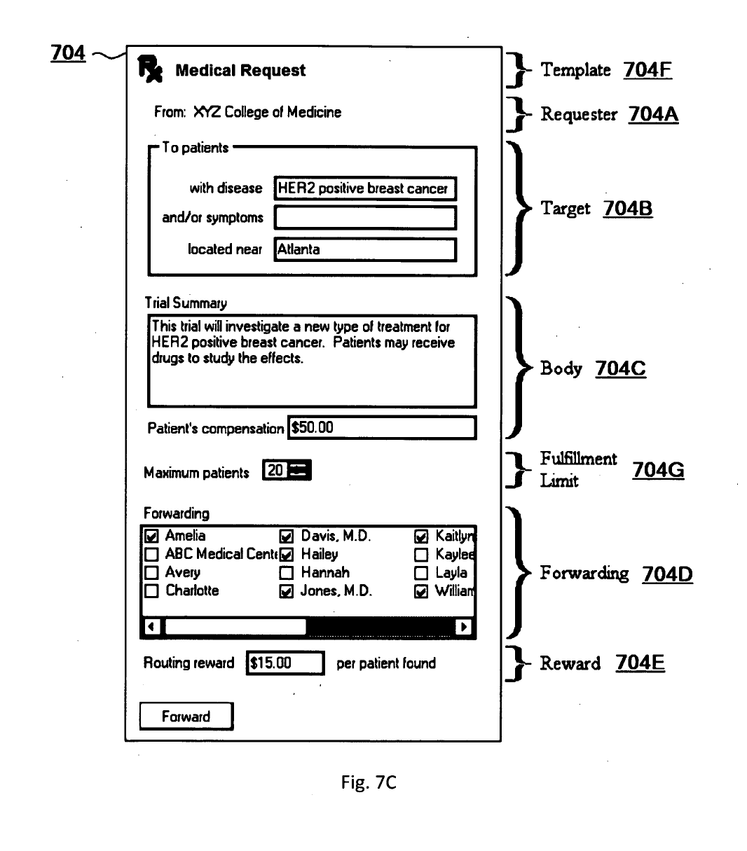

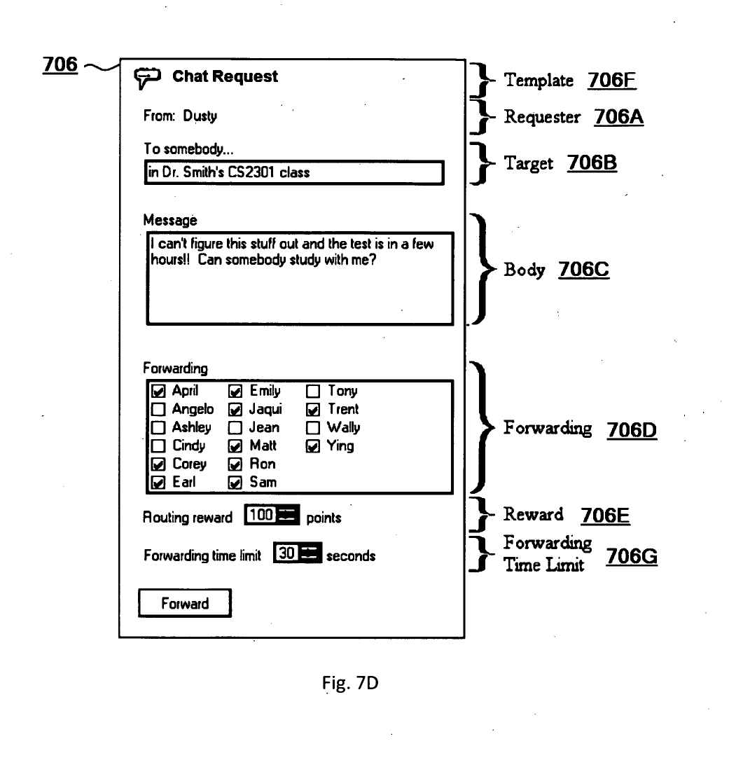

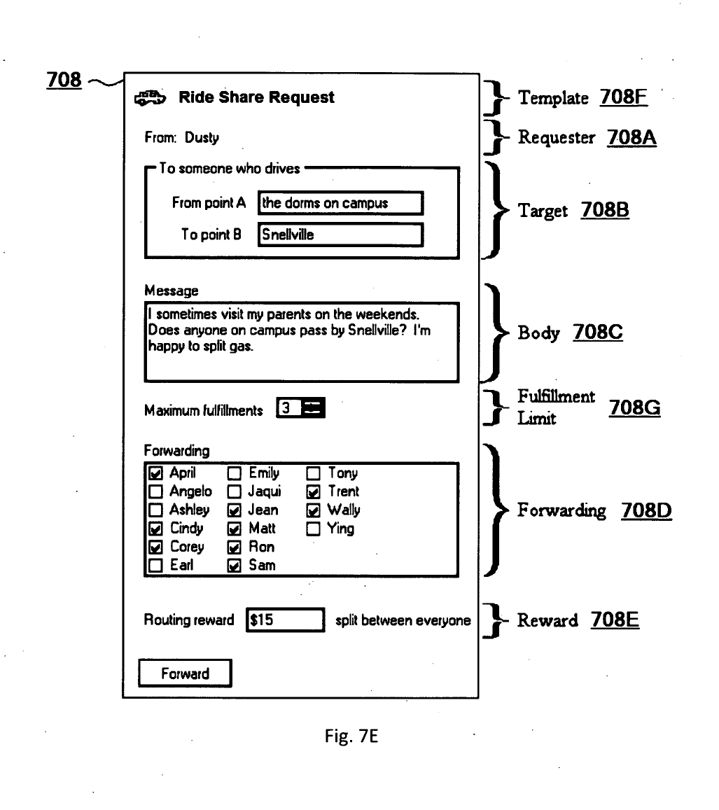

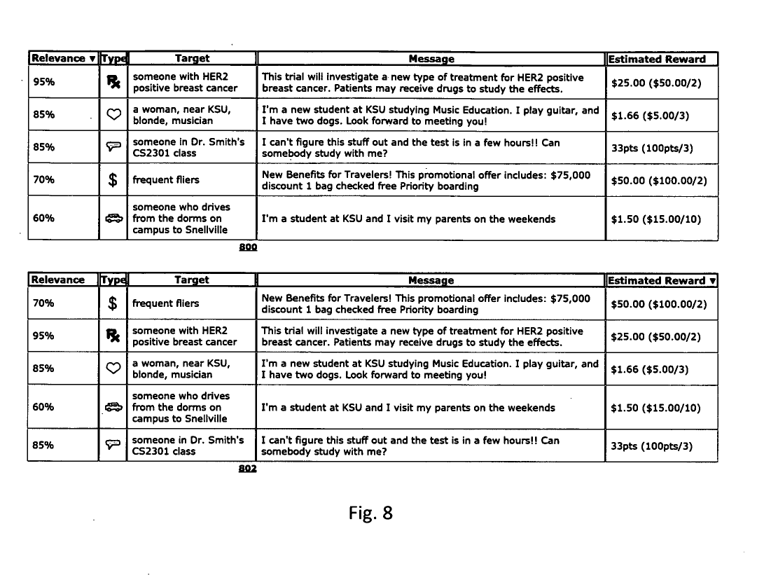

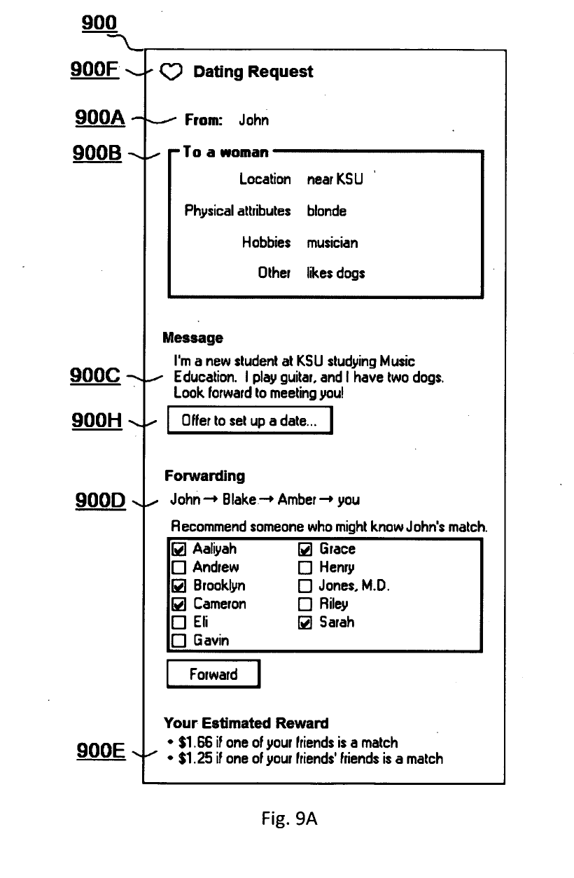

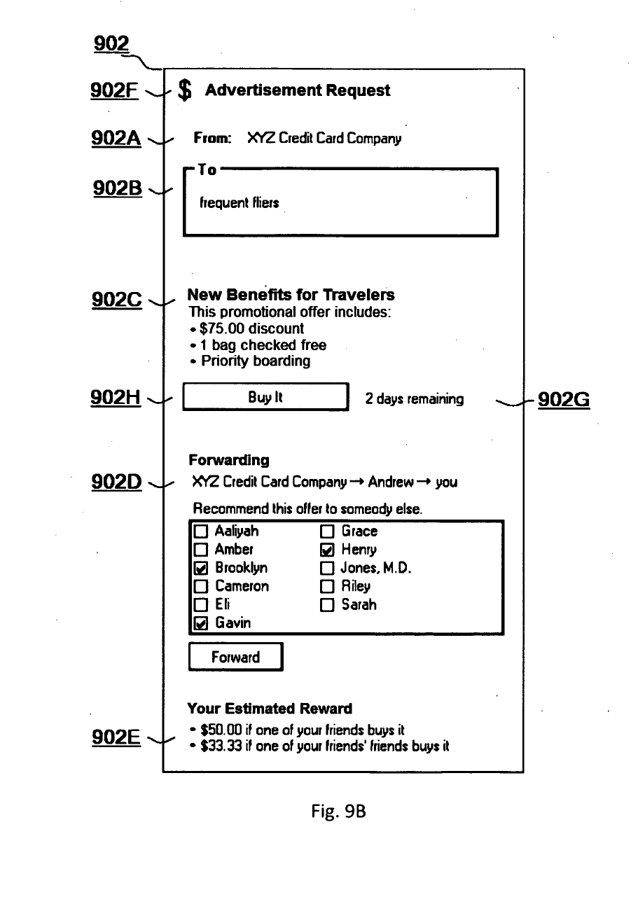

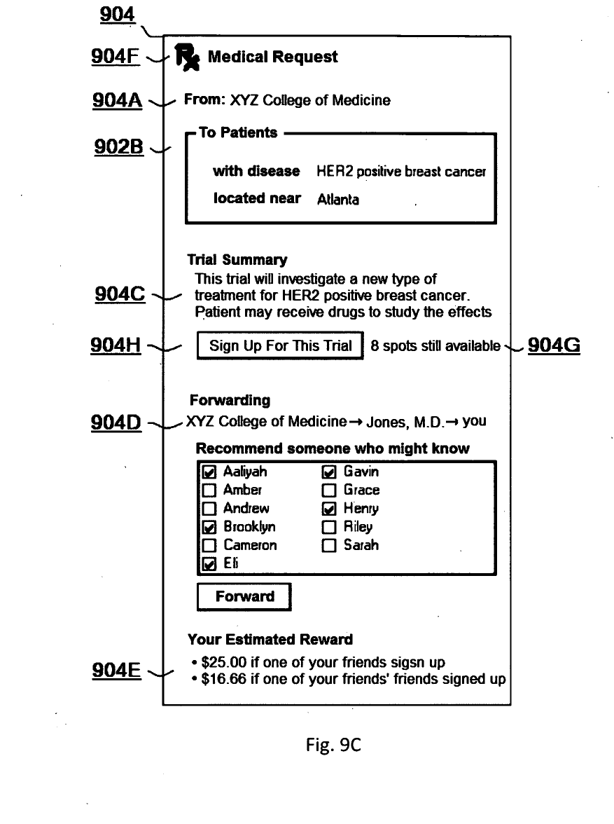

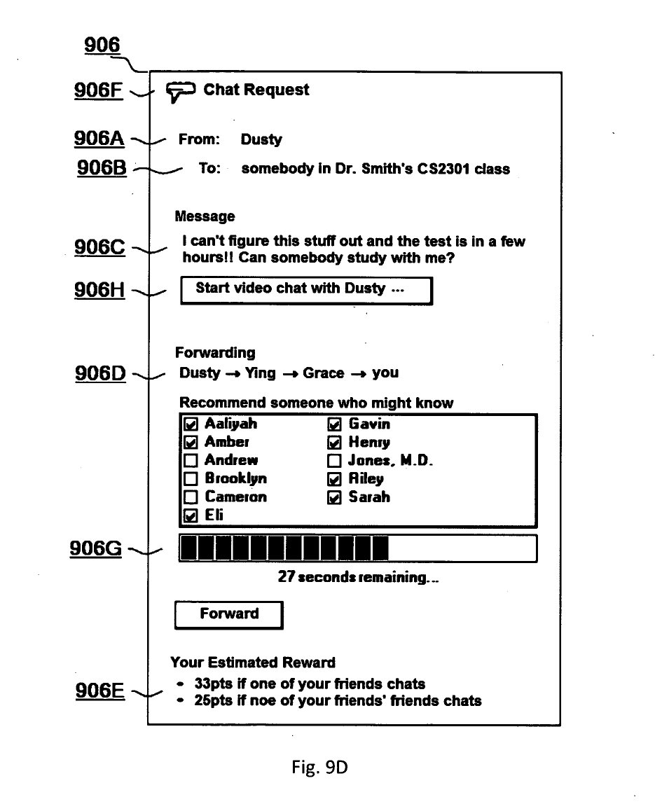

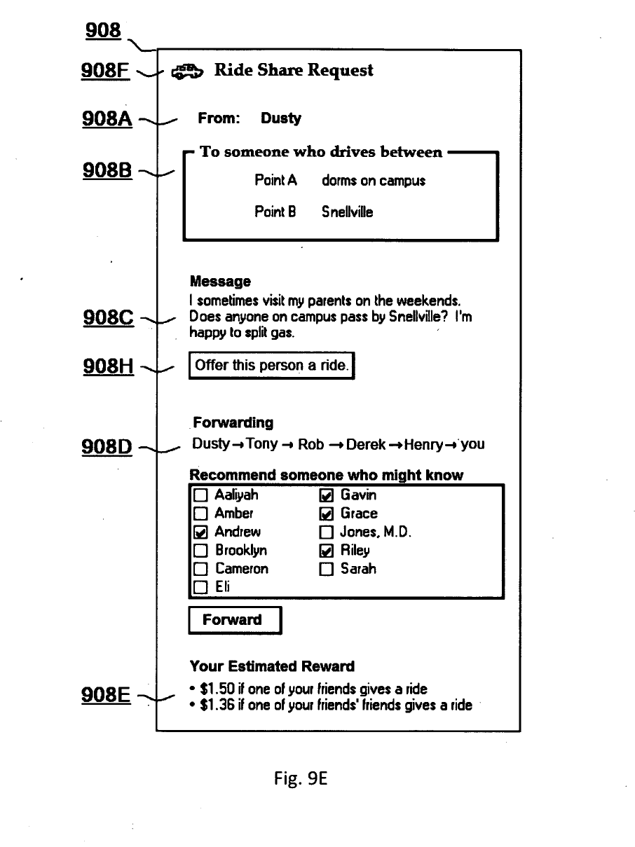

FIG. 7A-7E, FIG. 8, and FIG. 9A-9E illustrate exemplary views of an example user interface to be provided by an exemplary embodiment of the routing and rewarding system 100 (FIG. 1). The user interface may be configured to provide options for creating, viewing, modifying, deleting, forwarding, rejecting requests and otherwise interacting with requests and other users. FIG. 7A-7E illustrate several exemplary request creation screens as discussed herein. FIG. 8 illustrates two views of an exemplary request inbox for viewing the collection of requests a user has received as discussed herein. FIG. 9A-9E illustrate several exemplary request view screens as discussed herein. Although FIG. 7A-7E, FIG. 8, and FIG. 9A-9E describe exemplary user screens, the arrangement, presentation, and/or display of user screens may vary and still remain within the scope of various embodiments.

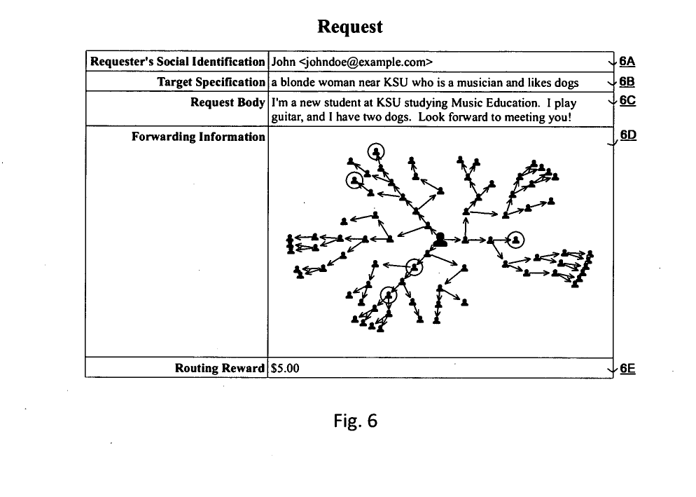

According to various embodiments, receiving request data comprises receiving parameters related to the requester's social identification, a target specification, a request body, a routing reward, and forwarding selections. FIG. 6 illustrates a table showing an exemplary request structure with sample data. According to one embodiment, a request comprises the requester's social identification 6A, a target specification 6B, a request body 6C, forwarding information 6D, and routing reward 6E. Referring to FIG. 7A-7E, note that each request creation screen 700-708 provides areas corresponding to the elements of the request. Referring to FIG. 9A-9E, note that each request view screen 900-908 provides similar content to the corresponding requests in FIG. 7A-7E.

According to one embodiment, a requester's social identification 6A comprises one or more pieces of information used to uniquely identify the requester within one or more social networks. For example, the requester may provide an OpenID, and/or an email address, and/or a handle from a professional social networking service, and so on. Referring to FIG. 6, John's email address is used as part of his social identification 6A.

A request's target specification 6B comprises information used to describe the user or type of user to whom the request should be delivered. The target specification could comprise any content such as keywords, a plain text description, example pictures, and so forth. Unlike other types of messaging, such as traditional mail or e-mail, the request does not need to be addressed to a unique or known target. Further, the target specification may be intended for human interpretation, and context may depend on knowledge about the forwarding user. Referring to FIG. 6, the requester uses a natural language description 6B of the person he hopes will accept his request. In FIG. 7A, the requester provides similar selections in the dating request's target specification area 700B. Unlike typical targeted advertising, some embodiments of the present invention incorporate human intelligence to match requests with users. Referring to FIG. 7A-7E, each request creation screen 700-708 provides an area for the user to make target specification selections 700B-708B. Note that, for the rideshare request 708 (FIG. 7E), the requester does not provide formal information about his school's location such as a street address or GPS coordinates. Instead, the receiving users may be able to interpret the target specification based on existing knowledge of the requester. For example, Dusty's friends may already know that he attends Kennesaw State University, which may help them to forward the request appropriately.

A request body 6C represents the primary content which the requester wishes to deliver to the target(s). The request body may comprise text (e.g., ASCII, HTML), images (e.g., jpeg, gif), audio (e.g., mp3), video (e.g., mpeg), documents (e.g., doc, pdf), embedded applications, and so forth and any combination thereof. Accordingly, the requester may be able to provide greater detail about the goal of the request and/or instructions for the request's fulfillment. Referring to FIG. 6, the requester provides a plaintext message 6C which he intends for the target user to read. Referring to FIG. 9A-9E, the receiving user is able to read the request body of each request 900C-908C.

According to some embodiments, a request's forwarding information 6D comprises data representing the record of all the request's forwards. For example, one embodiment of the forwarding information may comprise a tree data structure wherein each parent node is associated with a reference to the forwarding user and each child node is associated with a reference to a receiving user. Accordingly, the forwarding information represents the collection of forwarding paths, which describes the request's progress through the social network(s). Referring now to FIG. 6, the request's forwarding information 6D is similar to the social graph shown in FIG. 4. Each user in each of the forwarding paths has access to the request. Referring to FIG. 4, user A 402A corresponds to the requester of the dating request 700A in FIG. 7A. User B 402B, user E 402E, and user R 402R correspond to the three users selected in the forwarding area 700D. Referring now to FIG. 9A-9E, each request view screen 900-908 shows the forwarding path 900D-908D by which the request reached the receiving user. Accordingly, the forwarding information may provide some level of authenticity by providing the friend-of-a-friend relationships that connect the requester to all other users who have access to the request. For example, referring to the dating request's forwarding path 900D (FIG. 9A), John forwards the request to his friend Blake who is a music major at KSU; Blake forwards the request to his friend Amber in his choral class, and Amber forwards the request to the current user whose screen is shown in the figure. Unlike typical dating services, users may be less anonymous.

The routing reward 6E may comprise anything of value such as virtual quantities (e.g., points, credits), money (e.g. U.S. dollars), coupons, and so forth. Referring to FIG. 6, the routing reward 6E is 5 U.S. dollars. The routing reward may be distributed after the request's fulfillment as discussed herein. Accordingly, users may have greater incentive to participate in the routing process. Referring to FIG. 7A-7E, each request creation screen provides an area for the requester to specify the routing reward 700E-708E. (Note that the medical trial request 704 (FIG. 7C) specifies a reward for the fulfiller(s) as part of the request body 704C, but this should not be confused with the routing reward 704E which is intended for the users who routed the request to the fulfiller(s).) According to one exemplary embodiment, a user may be associated with an account used to send and/or receive reward. In another example, the user may be associated with information used for transferring reward through an e-commerce service.

According to some embodiments, a request may further comprise a value indicating the number of times the request has been fulfilled. According to various embodiments, the request further comprises a fulfillment limit which specifies the maximum number of times the request can be fulfilled, after which the request will expire. For example, a vendor having ten widgets in stock may create a request that can be fulfilled only ten times. Referring to FIG. 7E, the rideshare request 708 specifies a fulfillment limit 708G of 3. Routing a request further comprises preventing forwarding of the request when the request's fulfillment count has reached the request's fulfillment limit according to an exemplary embodiment.

According to particular embodiments, a request further comprises a routing deadline which specifies date and/or time information for determining when the request will expire. For example, a request to attend a sale held at a certain store may expire the day the sale ends at the time the store closes. Referring to FIG. 7B, the advertising request 702 specifies a fulfillment deadline 702G of Oct. 3, 2014. Referring to FIG. 9B, the receiving user is able to see the amount of time she has left 902G to sign up for the credit card. Routing a request further comprises preventing forwarding of the request when the request's fulfillment deadline has been reached according to an exemplary embodiment.

According to some embodiments, requests may be stored, retrieved, modified, and so forth to any storage medium, such as data store 210. According to an exemplary embodiment, the routing and rewarding system 100 (FIG. 1) and/or the user interface may be configured to allow users to retrieve request data using network addresses. For example, when a forwarding user forwards the request to a receiving user who is an email contact, the routing and rewarding system 100 (FIG. 1) may send an email to the receiving user containing a uniform resource locator (URL) which may be used to access the request.

According to some embodiments, a request may further be associated with one or more templates. Multiple requests may be associated with the same template. A template comprises any instructions for adapting the request content and/or user interface to better suit a specific purpose. For example, a template may be associated with a classification (hereinafter also referred to as “type”) such as “job request”, “dating request”, “chat request”, and so forth. Referring to FIG. 7A-7E, many exemplary default elements have been provided in the creation screens to reflect each request's associated template (indicated by the titles 900E-908F (FIG. 9A-9E)). For example, the target specification area of the dating request 900B (FIG. 9A) refers to the gender of the target while the forwarding area of the advertisement request 902B (FIG. 9B) does not. Although FIG. 9A-9E show five templates (e.g, a dating template, an advertisement template, a clinical trial template, a chat template, and a rideshare template), fewer or more templates with alternate fields may be made available and still fall within the scope of various embodiments. According to some embodiments, receiving parameters related to a request further comprises first receiving selection input indicating the desired template, and updating the request creation interface to match the selected template. For example, the requester may first select “dating request” from a list of available requests to access the dating request screen 700 (FIG. 7A).

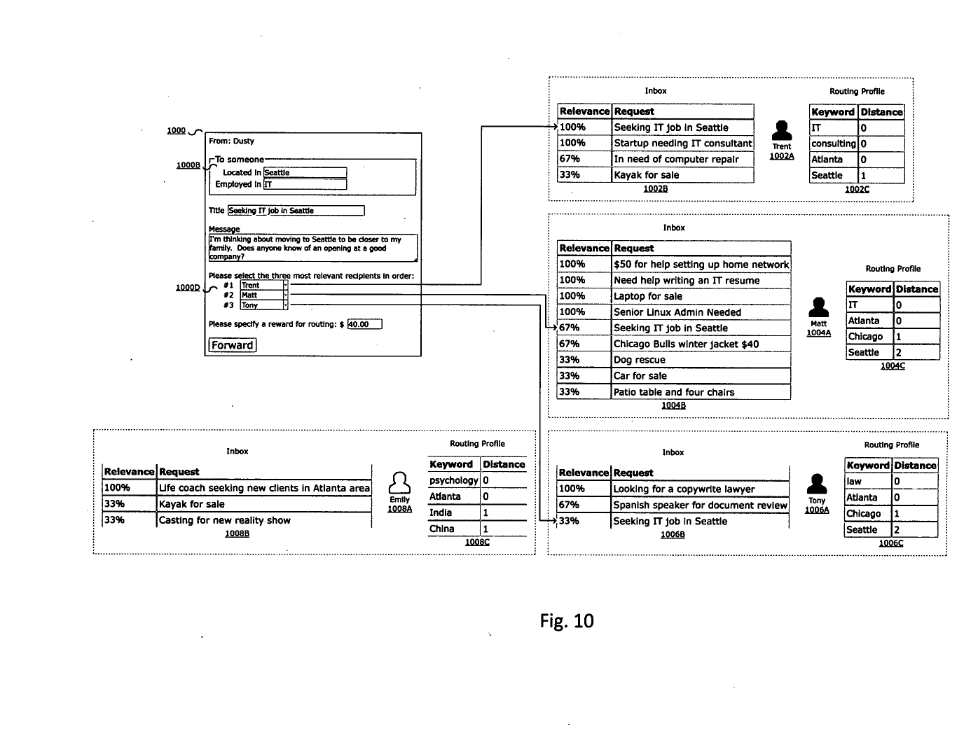

According to some embodiments, determining, from the connections of a forwarding user, one or more receiving users who appear best suited to route the request toward the request's target(s) comprises receiving from the forwarding user selections indicating the desired connections to receive the request. Referring to FIG. 7A-7E, each request creation screen provides a forwarding area 700D-708D where the user can select to which of his/her connections the request should be forwarded. For example, connections selected with a check mark are forwarded the request while connections without a check mark are not. Referring to the advertisement request 702 (FIG. 7B), the commercial company may be permitted to forward to all of its connections by selecting the “select all” checkbox. (Note that XYZ Credit Card Company's connections are assumed to be users who elect to receive requests from the XYZ Credit Card Company.) Referring now to FIG. 10, the forwarding area 1000D provides one or more drop down menus, each populated with a list of all or some of the forwarding user's connections. The forwarding user can select one or more connections for each of the drop down menus. After the forwarding user has selected the desired connections, the requester can select a “forward” button, or any other mechanism for forwarding the request. Although the forwarding area has been described as using certain controls (checkboxes, drop down menus, and buttons), other controls may be used and still fall within the scope of various embodiments.

According to some embodiments, the user interface and/or routing and rewarding system 100 (FIG. 1) may be further configured to allow a receiving user to reject the received request, indicating that the user does not wish to interact with the request, by storing a record of the rejection of the request for the user. For example, a receiving user may be able to select a “reject” button, or any other mechanism for rejecting, on the request view screen, and the request may be removed from the user's request inbox.

According to various embodiments, determining, from the connections of a forwarding user, one or more receiving users who appear best suited to route the request toward the request's target(s) further comprises, for each of the forwarding user's connections, determining whether the request is blocked by the connection, and when the request is determined to be blocked by the connection, excluding the connection as a receiving user. For example, a user may be able to block requests based on their type (indicated by the associated template), keywords in the target specification and/or request body, and so on. Accordingly, a user may be able to prevent receiving unwanted requests from other users. According to particular embodiments, the user interface and/or routing and rewarding system 100 (FIG. 1) may be further configured to allow a user to block requests that are similar to another request. For example, a receiving user may be able to select a “block similar requests” button, or any other mechanism for blocking requests, on the request view screen associated with a particular request. The routing and rewarding system 100 (FIG. 1) may then disallow forwarding of requests to the user when requests are identified as similar to the request blocked. Identifying similarity may be accomplished by comparing any combination of the requests' text, type (identified by the template), forwarding user, and/or any other request data.

According to some embodiments, the routing and rewarding system 100 (FIG. 1) may be configured to maintain a routing profile for each user, the routing profile comprising content data and associated metric data from requests previous routed by the user. Content data may comprise any data extracted from a request used for comparison with other requests, such as the request's type, or keywords from the request's target specification and/or request body. Metric data may comprise any values extracted from a request's forwarding information that may be used to make routing decisions. Exemplary embodiments of metric data may comprise the number of hops (i.e. forwarding path segments from one user to the next) from a user to the nearest fulfiller of such requests, the time taken to route such requests, the reward for such requests, and so forth. FIG. 10 shows several exemplary routing profiles 1002C-1008C. The routing profiles are populated with keywords and hop counts. The keywords are recorded from the target specifications of previous requests routed by the corresponding user 1002A-1008A. The “distance” fields (also referred to as “hop count”) represent the distance in the successful forwarding path from the receiving user to the fulfiller of the request associated with the corresponding keyword. Referring to Trent's routing profile 1002C, the hop count associated with the keyword “IT” is 0, indicating that Trent fulfilled a request containing the word “IT” in the target specification. The distance associated with the keyword “Seattle” is 1, indicating that a friend of Trent fulfilled a request containing “Seattle” in the target specification. Referring to Matt's routing profile 1004C, the distance associated with the keyword “Seattle” is 2, indicating that a friend of a friend of Matt fulfilled a request containing “Seattle” in the target specification. According to some embodiments, a congestion routing metric is calculated for a user at least in part using the frequency of the user's forwards and/or the number of received requests the user has not yet forwarded. According to some embodiments, routing profiles may be stored, retrieved, modified, and so forth to any storage medium, such as data store 210.

According to some embodiments, the user interface and/or routing and rewarding system 100 (FIG. 1) may be further configured to display a collection of received requests to the user. FIG. 8 illustrates two views 800-802 of the same exemplary request inbox. The exemplary request inbox comprises a table of rows and columns. Each row corresponds to a received request, such as the requests 700-708 created in FIG. 7A-7E. The user may be able to select a row in the request inbox and view the corresponding request on a request view screen, such as the request view screens 900-908 in FIG. 9A-9E. Each column of the request inbox corresponds to a property related to the individual request. A personal relevance rank, a type, a target specification, request body content, and a reward are provided for each received request in the exemplary request inbox. According to various embodiments, a routing and rewarding system 100 (FIG. 1) is further configured to calculate a personal relevance rank for a request and a user based at least in part on the request's data and the user's routing profile. Accordingly, it may be possible to estimate the user's level of interest for each received request. The personal relevance rank may comprise any data type, such as a percentage, an integer, a fractional number, and so on. The “type” column corresponds to the template type. The “target” column corresponds to the individual request's target specification. The “message” column corresponds to individual request's body. The “reward” column displays an estimated reward for the individual request calculated by dividing the request's reward by the number of rewardable users in the forwarding path. The first request inbox 800 shows the received requests sorted by relevance. Accordingly, the user may be able to find personally interesting requests more readily. The second request inbox 802 shows the received requests sorted by reward. Accordingly, the user may be able to find better rewards more readily.

FIG. 10 shows several exemplary request inboxes 1002B-1008B, one for each user 1002A-1008A. Each shows only two fields, “relevance” and “request”. The “relevance” field corresponds to the personal relevance rank of each received request, and the “request” field corresponds to the title field from the request body of each received request.

According to some embodiments, routing further comprises determining weights for each receiving user, the weights representing estimated relevance of the request to each of the individual receiving users. For example, the forwarding user may specify that the request is 100% relevant to one receiving user but only 10% relevant to another receiving user.

According to some embodiments, determining weights for each receiving user may be accomplished by calculating a weight for each receiving user based at least in part on the receiving user's position in an ordered list. For example, a forwarding user may be able to indicate relative weights by ordering a list of connections from most relevant to least relevant. FIG. 10 illustrates an exemplary diagram showing a request 1000 and four of the forwarding user's connections 1002A-1004A. Each of the forwarding user's connections is associated with a request inbox 1002B-1008B and a routing profile 1002C-1008C. The forwarding user's screen 1000 shows a forwarding area 1000D for selecting the three receiving users to whom the request is believed to be most relevant. As discussed herein, each drop down menu contains a list of all the forwarding user's connections from which the forwarding user can select one. The first selection (#1) indicates the estimated most relevant receiving user 1002A. The second selection (#2) indicates the next estimated most relevant receiving user 1004A. And the third selection (#3) indicates the next estimated most relevant receiving user 1006A. (Note that 1008A is a non-receiving user.) When the user clicks the “forward” button, weights may be calculated by the user interface and/or the routing and rewarding system 100 (FIG. 1) based on an inverse linear function. Although this example uses an inverse linear function, other functions or algorithms may be used and still fall within the scope of various embodiments.

According to some embodiments, the routing and rewarding system 100 (FIG. 1) may be further configured to generate forwarding predictions based at least in part on data from the request and data from one or more routing profiles. Forwarding predictions may comprise a set of the forwarding user's connections who are estimated as most likely to route the request closer to the target(s). Forwarding predictions may further comprise relevance weights associated with the forwarding user's connections according to an exemplary embodiment. Referring to FIG. 7B, the requester associated with the advertising request 702 has 1,000 connections. In this exemplary embodiment, the forwarding area reflects default selections corresponding to forwarding predictions of the 500 connections estimated as most likely to route the request to the targets. Accordingly, the default selections may help the forwarding user to make forwarding selections faster. Referring now to FIG. 10, the forwarding area of the request screen 1000D may be pre-populated with selections of users who appear to route better for the attributes within the request's target specification 1000B based on shortest hop counts. “Seattle” and “IT” are two keywords found within the target specification 1000B of the request to be forwarded. Comparing Trent's routing profile 1002C to Matt's routing profile 1004C, both indicate a hop count of 0 for “IT”, but Trent's routing profile 1002C indicates a hop count of 1 for “Seattle”, which is shorter than the hop count of 2 indicated in Matt's routing profile 1004C; therefore, Trent 1002A may appear to route better for the attributes based on shorter hop counts for this request 1000 than Matt 1004A. Based on such comparisons for each user, in preferred embodiments, it is possible to estimate the three most relevant users and select them by default. The forwarding user may then change the selections before forwarding if desired.

According to some embodiments, determining, from the connections of a forwarding user, one or more receiving users who appear best suited to route the request toward the request's target(s) comprises calculating forwarding predictions based on the routing profile of the forwarding user and data from the request. Accordingly, requests may be routed automatically, without direct intervention from users, even when users who have access to the request are inactive or offline, which may allow requests to route faster through the one or more social networks. (Routing without direct intervention from a user is also referred to herein as “automatic routing”.)

According to some embodiments, the request may further comprise a forwarding time limit used to determine when automatic routing may occur. Referring to the chat request creation screen 706 in FIG. 7D, the requester 706A specifies a forwarding time limit 706G of 30 seconds. Referring now to FIG. 9D, the chat request view screen 906 includes a progress bar 906G which is updated to indicate the amount of time the user has left to forward the request before it will be automatically routed. If the user does not forward before the time expires, the request will be forwarded to the users currently selected (Aaliyah, Amber, Eli, Gavin, Henry, Riley, and Sarah).

According to some embodiments, a forwarding time limit may be calculated dynamically based at least in part on the request's routing deadline. For example, if the routing deadline is set to 1 hour and the average successful path length is 10, then the forwarding deadline for each hop might be calculated by dividing 1 hour by 10, equaling 1 minute.

According to some embodiments, determining, from the connections of a forwarding user, one or more receiving users who appear best suited to route the request toward the request's target(s) further comprises limiting the total number of receiving users from the forwarding user based on a forwarding volume limit. Referring now to FIG. 10, the forwarding volume limit is apparently 3. Only three receiving users can be selected in the forwarding area 1000D. Accordingly, the forwarding volume limit may prevent excessive broadcasting which, in turn, may help to control the total number of requests that users receive from their connections. In other words, the forwarding volume limit may be used to control “spamming” of requests. Although the forwarding volume limit is set to a value of 3 in the exemplary figure, other values may be used and still fall within the scope of various embodiments. According to various embodiments, the forwarding volume limit may change dynamically based on such data as user activity and congestion (which might, for example, be determined based on a user's volume of received requests and/or the rate at which the user routes requests). For example, requesters who appear to avoid spamming may earn a higher forwarding volume limit than users who may be suspected of spamming.

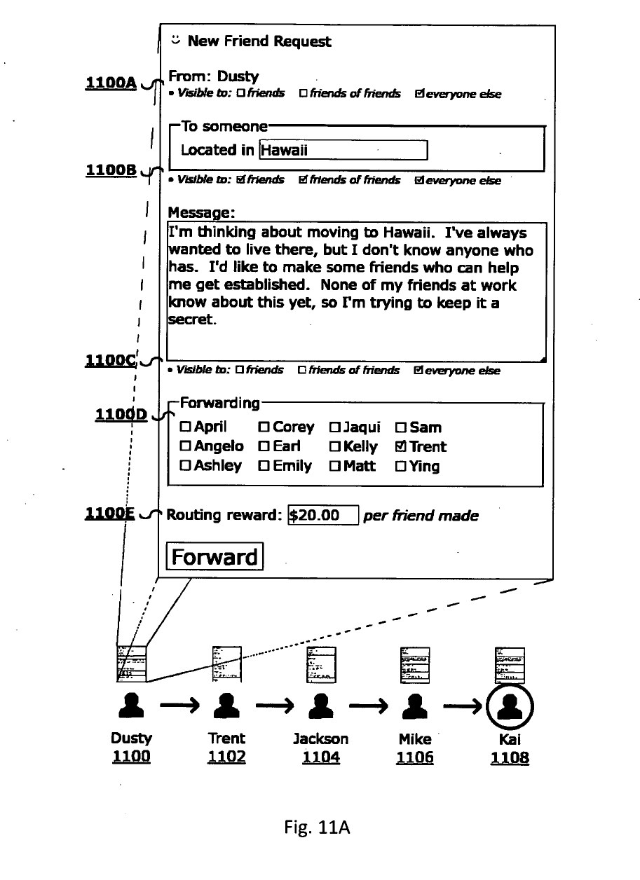

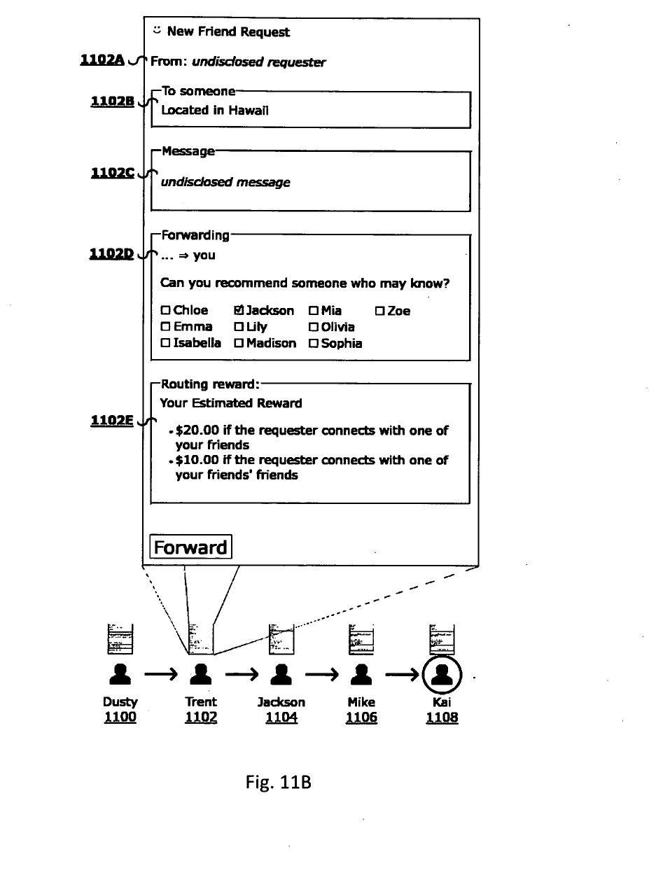

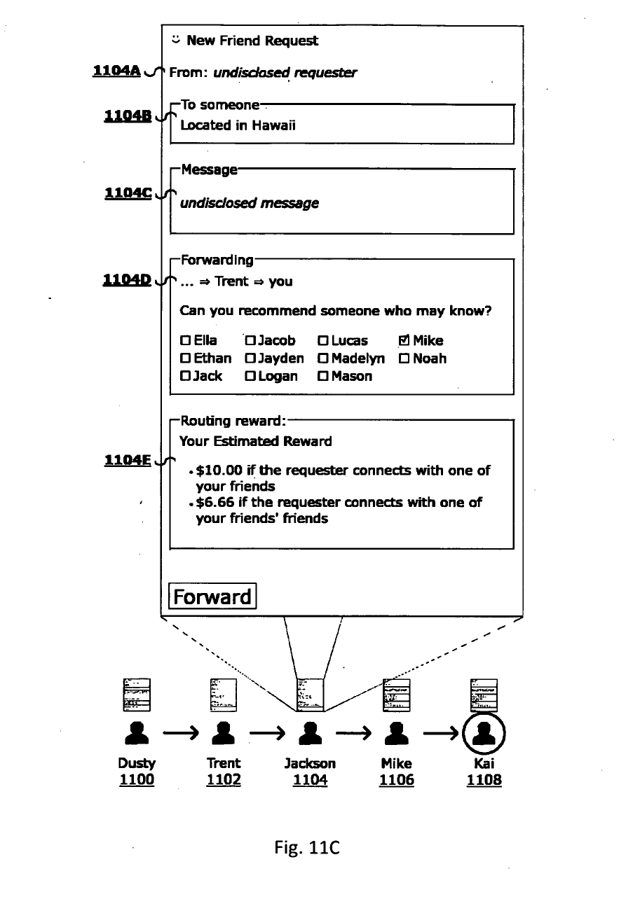

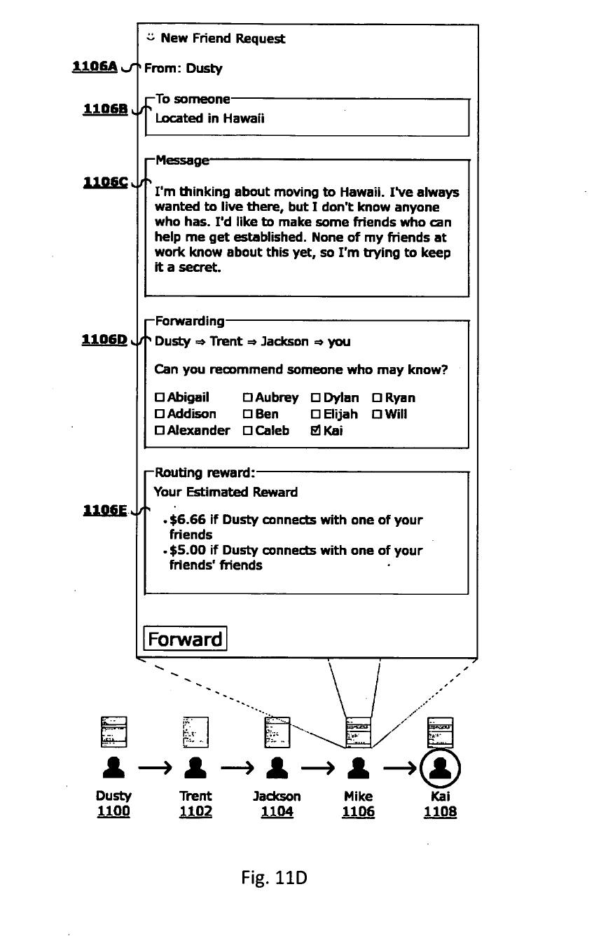

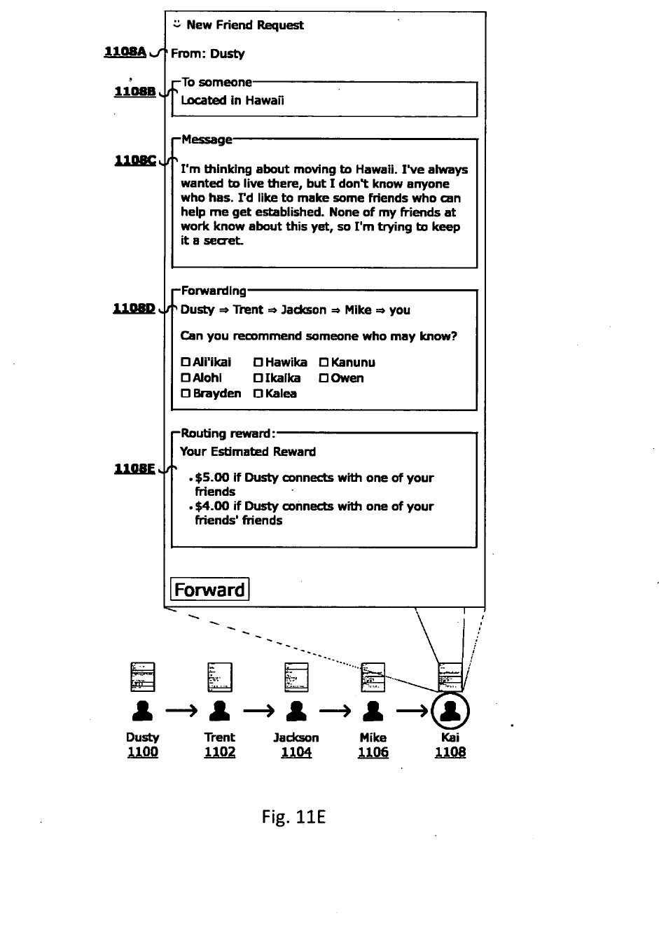

According to some embodiments, a request may further comprise data specifying the portions of request data that are visible to another user based on the request's forwarding information. FIG. 11A-11E illustrates an exemplary forwarding path and exemplary screens associated with each user. The requester can specify the visibility of various pieces of information, such as the requester's social identification 1100A (FIG. 11A), the target specification 1100B, and the request body 1100C, and so on based on certain criteria related to the request's forwarding information. For example, the requester specifies that the request body should be hidden from “friends” and “friends of friends” by unchecking the corresponding checkboxes 1100C; therefore, neither Trent 1102 (FIG. 11B) nor Jackson 1104 (FIG. 11C) have access to the request body 1100C (FIG. 11A).

When a user has access to a request, the user may wish to fulfill the request. According to some embodiments, fulfilling a request comprises receiving input selections from a user who has access to the request (hereinafter referred to as the acceptor) related to the acceptor's acceptance to fulfill the request, and receiving input selections from the requestor confirming the fulfillment of the request by the acceptor. Referring to FIG. 9B, the advertisement request 902 allows the receiving user to accept the requester's offer by clicking a button 902H. The requester then confirms the transaction, indicating that the request has been fulfilled.

According to some embodiments, fulfilling a request comprises receiving input selections from a user who has access to the request (hereinafter referred to as an “offeror”) related to the offeror's offer to fulfill the request, optionally receiving input selections from the requester and/or the offeror related to negotiations, receiving input selections related to the requester's acceptance or rejection of the offer, and when the input selections related to the requester's acceptance of the offeror's offer are received, receiving input selections related to the requester's confirmation of the fulfillment of the request by the offeror. Accordingly, the requester and the offeror may be able to better negotiate terms of the request's fulfillment. Also, the requester may be able to choose the preferred offeror(s) to fulfill the request. For example, the requester of an auction request may choose the offeror or offerors who submit the highest bids. Referring to FIG. 3, steps 4 through 6 show an exemplary interaction between the requester 300A and the offeror 300D leading to fulfillment. At step 4, User A 300A receives a communication notifying that User D 300D is offering to fulfill the request. At step 5, user D 300D receives a communication notifying that user A 300A accepts the offer. At step 6, user A 300A confirms that user D 300D fulfilled the request. Referring now to FIG. 9A, the dating request 900 allows the receiving user to make an offer to set up a date by clicking a button 900H. The offeror may also be able to communicate with the requester, for example, explaining why she and the requester might be a good match. The requester may then accept the offer. The requester and offeror may be able to communicate, for example, to negotiate meeting times, locations and so forth according to exemplary embodiments. Later, the requester may confirm that the date occurred, indicating that the request has been fulfilled.

According to some embodiments, fulfilling a request further comprises resolving conflict. In one embodiment, resolving conflict comprises receiving input selections from a user of a forwarding path related to a complaint, receiving input selections from one or more users of the forwarding path and a moderator relating to consultation, receiving input selections related to the moderator's judgment, notifying at least the requester and/or the offeror of the judgement, and optionally, when the requestor is at fault, receiving input selections related to the requestor's contest of the judgement within a predefined amount of time. A moderator may comprise any user granted the authority to mediate conflicts. When the requester is found to be at fault and the predefined amount of time is exceeded, the request may be considered fulfilled by the offeror according to an exemplary embodiment.

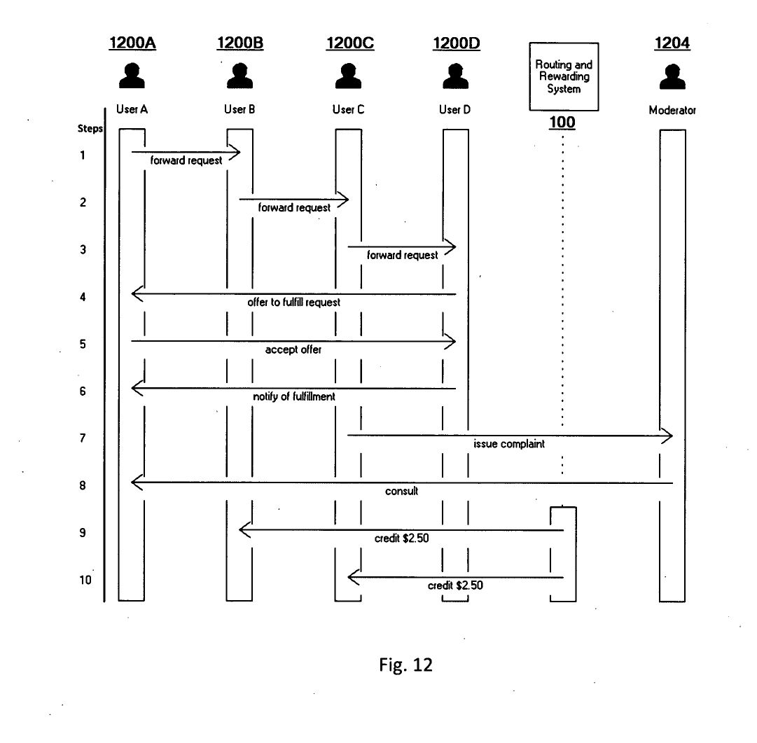

FIG. 12 illustrates an exemplary sequence diagram describing an exemplary scenario in which the acceptor 1200D fulfills all the requirements that the requester 1200A specified, but the requester 1200A neglects to confirm the fulfillment. The offeror's friend, user C 1200C, knows the request has been fulfilled and expects reward. At step 7, user C 1200C issues a complaint. At step 8, a moderator 1204 contacts the requester 1200A and determines that the request has been adequately fulfilled.

Although fulfilling a request has been described using the above exemplary methods, other methods for fulfilling a request may be used and still fall within the scope of various embodiments.

When the request has been fulfilled, rewardable users may be rewarded. According to various embodiments, rewarding rewardable users based on a request's successful forwarding path(s) comprises determining rewardable users based on the request's successful forwarding path(s), and distributing the request's routing reward to the rewardable users. Rewardable users of a successful forwarding path comprise the users of the successful forwarding paths excluding the requester and optionally excluding the fulfiller. According to one embodiment, determining rewardable users based on a request's successful forwarding path(s) comprises determining the rewardable users of a single successful forwarding path based on a reference to a fulfiller by, starting with the reference to the fulfiller, traversing back through the request's forwarding information by references to forwarding users until the reference to the requester is reached, and selecting each of the references to users traversed, excluding the reference to the requester and optionally excluding the reference to the fulfiller. Referring now to one successful forwarding path in FIG. 5, user A 502A→user B 502B→user C 502C→user D 502D, the rewardable users are user B 502B, user C 502C, and possibly user D 502D. After user D 502D has fulfilled the request, those rewardable users might be determined by, starting with user D 502D, following back to user C 502C (the forwarding user of user D 502D), from user C 502C to user B 502B, and from user B 502B to user A 502A, the requester. When this method is performed for each of a request's fulfillers, all of the request's rewardable users can be determined. According to various embodiments, the requester may be able to select whether fulfillers are rewardable. In the above mentioned examples, fulfillers are assumed not rewardable.

According to some embodiments, determining rewardable users based on a request's successful forwarding path(s) comprises selecting all of the rewardable users from all of the request's successful forwarding paths at once. For example, the rideshare request 708 in FIG. 7E specifies $15.00 total for all fulfillments 708E. Reward is not distributed until the request has expired. When the request has expired, all the request's rewardable users receive a portion of $15.00.

According to alternative embodiments, determining rewardable users based on a request's successful forwarding path(s) comprises selecting the rewardable users from one successful forwarding path at a time. For example, the advertisement request 702 in FIG. 7B specifies $100.00 for each fulfillment 702E (i.e. each time a card is activated). When the first card is activated, $100.00 is distributed among the rewardable users from the associated successful forwarding path. When the second card is activated, another $100.00 is distributed among the rewardable users from the associated successful forwarding path. Accordingly, rewardable users of earlier successful forwarding paths may not be forced to wait for rewardable users of later successful forwarding paths to be determined before receiving reward.

According to some embodiments, distributing a request's routing reward to rewardable users comprises calculating the amount of the request's routing reward to be distributed to each rewardable user by evenly dividing the amount of the request's routing reward by the total number of rewardable users. Accordingly, each of the rewardable users will receive an equal amount of routing reward. Referring now to FIG. 3, there are two rewardable users: user B 300B and user C 300C. Therefore, the reward is divided in half and $2.50 is distributed to both.

According to other embodiments, distributing a request's routing reward to rewardable users comprises calculating an amount of the request's routing reward for each of the rewardable users proportionally based on relative values of one or more attributes associated with each rewardable user compared with the other rewardable users. According to one exemplary embodiment, the amount of routing reward for a rewardable user is positively related to the total number of the request's successful forwarding paths including the rewardable user. Accordingly, users who strive to maximize fulfillments may receive greater reward. According to another exemplary embodiment, the amount of routing reward for a rewardable user is negatively related to the total number of receiving users to whom the rewardable user forwarded the request. Accordingly, users who spam requests may receive lesser reward. Other exemplary embodiments may use combinations of the two previously described methods.

Unlike conventional revenue sharing services, embodiments of the present invention may encourage users to forward more conscientiously in order to minimize the number of users with whom reward must be shared, thereby increasing relevance to receiving users and reducing spam. Poor routing decisions will likely result in longer forwarding paths, which will likely correspond to diminished reward. For example, if the forwarding volume limit is 1 (meaning the user can only forward the request to one friend), the user's best option is to forward to the friend who is most likely willing to fulfill the request. Otherwise, the user's next best option is to forward to the friend who likely has other friends willing to fulfill the request.

The components and methods described herein can be comprised of computer-executable instructions such as software, routines, data structures, and so on and stored on any form of computer-readable media according to various embodiments. Those skilled in the art can implement various embodiments of the invention according to the description and figures provided above.

For the sake of simplicity, some unnecessary information that would be considered obvious to a person skilled in the art is omitted from the above description. Furthermore, while the invention has been described in connection with specific embodiments in the foregoing specification, it should be understood that the above-described embodiments have been provided by way of illustration only and cannot be construed in the sense of limitation. Accordingly, various modifications and changes may be made to the exemplary embodiments set forth herein and still fall within the spirit and broader scope of the invention.

### REFERENCES

### Incorporated Herein by Reference

1 Catfishing: New Label for Old Scam, http://www.bbb.org/blog/2013/01/catfishing-new-label-for-old-scam/, 2 pages, (2014).
2 Facebook Explains How Often Your Posts Actually Get Seen, http://www.huffingtonpost.com/2012/02/29/facebook-posts_n_{—}1311330.html, 2 pages, (2012).
3 Small-World Experiment from Wikipedia, http://en.wikipedia.org/wiki/Small_world_experiment, 7 pages, (2013).
4 Study: Only 1% of Facebook ‘Fans’ Engage With Brands, http://adage.com/article/digital/study-1-facebook-fans-engage-brands/232351/,2 pages, (2011).

What is claimed is:

1. A computer-implemented method for social request routing and reward distribution, the method comprising:
creating, by a processor, a request;
routing, by a processor, the request between one or more users of one or more social networks;
fulfilling, by a processor, the request; and
rewarding, by a processor, rewardable users based on the request's successful forwarding path(s).

2. A computer-implemented method according to claim 1 wherein creating a request comprises:
receiving data related to a request from a requester, the data comprising:
the requester's social identification;
a target specification;
a request body;
a routing reward; and,
forwarding information; and,
storing the request on a non-transitory computer-readable medium.

3. A computer-implemented method according to claim 2, wherein receiving data related to a request further comprises:
prior to receiving data related to a request from a requester, receiving selection input from a requester indicating the desired template; and,
updating the creation screen to match the selected template.

4. A computer-implemented method according to claim 2, wherein receiving data related to a request further comprises:
receiving input selections specifying the portions of the request's data that are visible to another user based on the request's forwarding information.

5. A computer-implemented method according to claim 1, wherein routing a request comprises:
determining, from the connections of a forwarding user, one or more receiving users who appear best suited to route the request toward the request's target(s); and,
forwarding the request to the one or more receiving users.

6. A computer-implemented method according to claim 5 wherein forwarding a request to a receiving users comprises:
storing data in the request's forwarding information indicating that the request has been forwarded to the receiving user; and,
granting, to the receiving user, access to the request.

7. A computer-implemented method according to claim 5 wherein determining, from the connections of a forwarding user, one or more receiving users who appear best suited to route the request toward the request's target(s) comprises:
receiving from the forwarding user input selections indicating the desired connections to receive the request.

8. A computer-implemented method according to claim 5 wherein determining, from the connections of a forwarding user, one or more receiving users who appear best suited to route the request toward the request's target(s) comprises:
calculating forwarding predictions based on the routing profile of the forwarding user and data from the request.

9. A computer-implemented method according to claim 5 wherein determining, from the connections of a forwarding user, one or more receiving users who appear best suited to route the request toward the request's target(s) further comprises:
limiting the total number of receiving users from the forwarding user based on a forwarding volume limit.

10. A computer-implemented method according to claim 5 wherein determining, from the connections of a forwarding user, one or more receiving users who appear best suited to route the request toward the request's target(s) further comprises:
for each of the forwarding user's connections, determining whether the request is blocked by the connection;
and when the request is determined to be blocked by the connection, excluding the connection as a receiving user.

11. A computer-implemented method according to claim 5 further comprising:
preventing forwarding of the request when the request's fulfillment count has reached the request's fulfillment limit.

12. A computer-implemented method according to claim 5 further comprising:
preventing forwarding of the request when the request's fulfillment deadline has been reached.

13. A computer-implemented method according to claim 5 further comprising:
calculating a forwarding time limit based at least in part on the request's forwarding deadline and the average length of successful forwarding paths.

14. A computer-implemented method according to claim 1 wherein fulfilling a request comprises:
receiving input selections related to an acceptor's acceptance to fulfill the request; and,
receiving input selections related to the requester's confirmation of the fulfillment of the request by the acceptor.

15. A computer-implemented method according to claim 1 wherein fulfilling a request comprises:
receiving input selections related to an offeror's offer to fulfill the request;
optionally, receiving input selections from the requester and/or the offeror related to negotiations;
receiving input selections related to the requester's acceptance or rejection of the offer; and,
when the input selections related to the requester's acceptance of the offeror's offer are received, receiving input selections related to the requester's confirmation of the fulfillment of the request by the offeror.

16. A computer-implemented method according to claim 1, wherein fulfilling the request further comprises resolving conflict within a forwarding path, the method comprising:
receiving input selections from a user of the forwarding path related to a complaint;
receiving input selections from one or more users of the forwarding path and a moderator relating to consultation;
receiving input selections related to the moderator's judgment;
notifying at least the requester and/or the offeror of the judgement;
and optionally, when the requester is at fault, receiving input selections related to the requester's contest of the judgement within a predefined amount of time.

17. A computer-implemented method according to claim 1, wherein rewarding rewardable users based on a request's successful forwarding path(s) comprises:
determining rewardable users based on the request's successful forwarding path(s); and,
distributing the request's routing reward to the rewardable users.

18. A computer-implemented method according to claim 17 wherein determining rewardable users based on a request's successful forwarding path(s) comprises:
determining the rewardable users of a single successful forwarding path based on a reference to a fulfiller by,
starting with the reference to the fulfiller, traversing back through the request's forwarding information by references to forwarding users until the reference to the requester is reached; and,
selecting each of the references to users traversed, excluding the reference to the requester and optionally excluding the reference to the fulfiller.

19. A computer-implemented method according to claim 17, wherein determining rewardable users based on a request's successful forwarding path(s) comprises:
selecting all of the rewardable users from all of the request's successful forwarding paths at once.

20. A computer-implemented method according to claim 17, wherein determining rewardable users based on a request's successful forwarding path(s) comprises:
selecting the rewardable users from one successful forwarding path at a time.

21. A computer-implemented method according to claim 17, wherein distributing a request's routing reward to rewardable users further comprises:
calculating an amount of the request's routing reward to be distributed to each rewardable user by evenly dividing the amount of the request's routing reward by the total number of rewardable users.

22. A computer-implemented method according to claim 17, wherein distributing a request's routing reward to rewardable users comprises:
calculating an amount of the request's routing reward for each of the rewardable users proportionally based on relative values of one or more attributes associated with each rewardable user compared with the other rewardable users.

23. A computing system for social request routing and reward distribution, the system being connected through a wired/wireless communication network and performing computer communication and operation processing, comprising:
at least one processor configured to:
creating a request;
routing the request between one or more users of one or more social networks;
fulfilling the request; and,
rewarding rewardable users based on the request's successful forwarding path(s);
a non-transitory computer-readable medium.

24. The system of claim 23 further configured to generate a user interface comprising:
a request creation screen for creating requests;
a request inbox for viewing received requests; and,
a request view screen for viewing requests.

25. The system of claim 23 wherein said processor is further configured to:
calculate a personal relevance rank for a request and a user based at least in part on the request's data and the user's routing profile.

26. A non-transitory computer-readable medium storing computer program instructions, which when executed by a processor, cause the processor to perform a method comprising the steps of:
creating a request;
routing the request between one or more users of one or more social networks;
fulfilling the request; and,
rewarding rewardable users based on the request's successful forwarding path(s).

27. The system of claim 26 wherein the processor when executing the code on the non-transitory computer-readable medium is further configured for storing a plurality of requests, a request comprising:
social identification;
target specification;
request body;
routing reward; and,
forwarding information.

28. The system of claim 26 wherein the processor when executing the code on the non-transitory computer-readable medium is further configured to:
for each user, store content data and metric data from requests previously routed by the user to the non-transitory computer-readable medium.
